(19) United States
(12) Patent Application Publication
(10) Pub. No.: US 2014/0307477 A1
(43) Pub. Date: Oct. 16, 2014

(54) LIGHT GUIDE PLATE WITH UNIFORM LIGHT OUTPUT AND METHOD OF MANUFACTURING SAME

(71) Applicant: HON HAI PRECISION INDUSTRY CO., LTD., New Taipei (TW)

(72) Inventor: LI-YING WANG HE, Tu-Cheng (TW)

(73) Assignee: HON HAI PRECISION INDUSTRY CO., LTD., New Taipei (TW)

(21) Appl. No.: 13/972,849

(22) Filed: Aug. 21, 2013

(30) Foreign Application Priority Data
Apr. 15, 2013 (TW) 102113334

(51) Int. Cl. F21V 8/00

(52) U.S. Cl. CPC G02B 6/0011; G02B 6/0065
USPC 362/621; 427/163.2

(57) ABSTRACT

A light guide plate includes a main body and a number of transparent particles. The main body includes a light incident surface, and defines a micro structure in the light incident surface. The transparent particles are made of material with a refraction index greater than the refraction index of the material of the main body and are attached on the light incident surface in the micro structure.

### BACKGROUND

1. Technical Field

The present disclosure relates to light guide plates, and particularly to a light guide plate capable of improving uniformity of light rays emitted therefrom and a method of manufacturing the light guide plate.

2. Description of Related Art

Light guide plates generally include a light incident surface, and define micro structures in the light incident surface. The micro structures are used to improve uniformity of light rays passing the light incident surface. In order to further improve uniformity of the light rays, the light incident surface is also roughened by an impressing process. However, as the micro structures are indented into the incident surface, access to a sidewall of the micro structures is restricted, which ultimately degrades the uniformity of the light rays.

Therefore, it is desirable to provide a light guide plate and a method of manufacturing the light guide plate, which can overcome the limitations described.

### BRIEF DESCRIPTION OF THE DRAWINGS

FIG. 1 is an isometric view of a light guide plate in accordance with a first exemplary embodiment.

FIG. 2 is an isometric view of a light guide plate in accordance with a second exemplary embodiment.

FIG. 3 is a flow chart of a method of manufacturing the light guide plate of FIG. 1 and FIG. 2.

### DETAILED DESCRIPTION

Embodiments of the disclosure will be described with reference to the drawings.

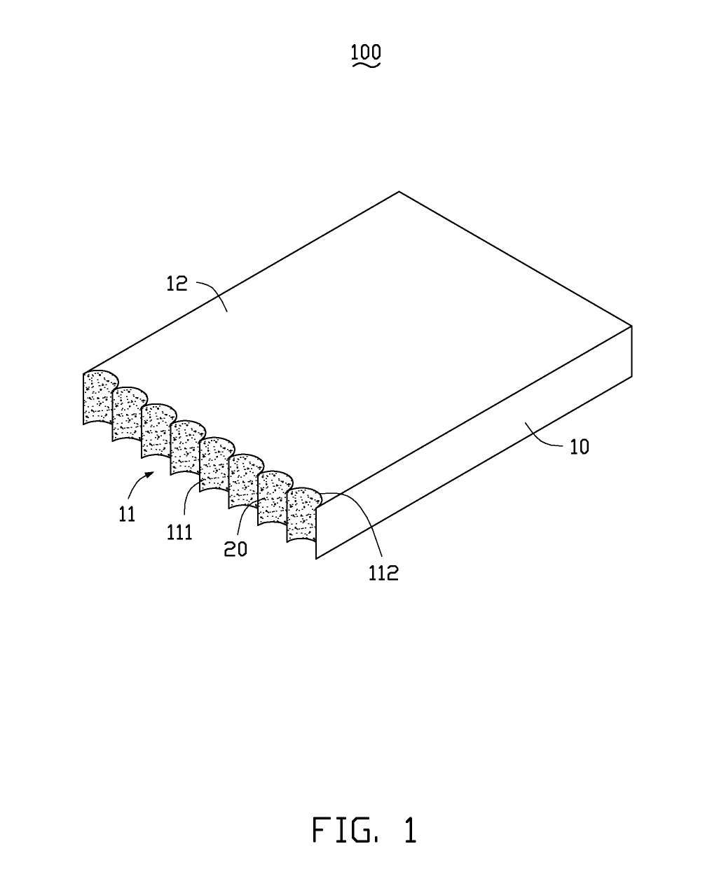

FIG. 1 shows a light guide plate 100, according to a first exemplary embodiment, which is used in a liquid crystal display (not shown). The light guide plate 100 is configured for converting a point light source or a line light source into a surface light source. The uniformity of the light rays which are output from the light guide plate 100 decides the degree of quality applied to the light guide plate 100.

The light guide plate 100 includes a main body 10 and a number of transparent particles 20 attached on the main body 10.

The main body 10 is a cuboid, and is made of a plastic material. A refraction index of the plastic material making the main body 10 is n1. The main body 10 includes a light incident surface 11 and a light emitting surface 12 perpendicular to the light incident surface 11. The main body 10 defines a micro structure 111 in the light incident surface 11. The micro structure 111 includes a number of recesses 112 defined in the light incident surface 11. The recesses 112 are regular or irregular arranged on the light incident surface 11.

The transparent particles 20 are formed by spraying a molten plastic material on the light incident surface 11 and the micro structure 111. In the embodiment, one part of transparent particles 20 are attached on an inner surface of the recesses 112. A refraction index of the plastic material making the transparent particles 10 is n2, wherein n2>n1. The shape of each transparent particle 20 is irregular. A size of each transparent particle 20 is far less than a size of the recess 112, which allows the transparent particles 20 to enter into the recesses 112 and attach on the inner surface of the recess 112.

In the embodiment, the transparent particles 20 are sprayed from a spreading device (not shown). The spreading device includes a molten chamber, an ignition chamber, and a mixing gas chamber. The plastic material is received and melted in the molten chamber. The ignition device in the ignition chamber lights a mixing gas received from the mixing gas chamber, and the burning mixing gas creates a great pressure in the molten chamber. The molten plastic material is sprayed out from the molten chamber under great pressure.

In use, light rays emitted from a light source (not shown) strike the light incident surface 11 of the light guide plate 100. The light rays also strike the transparent particles 20. As the shape of each transparent particle 20 is irregular, the light rays falling on the transparent particles 20 are reflected or refracted along different directions. As the refraction index n2 of each transparent particle 20 is greater than a refraction index n1 of the main body 10, a refraction angle of the light rays is greater than an incident angle of the light rays. Thus some light rays will travel into the micro structure 111 after penetrating the transparent particles 20, and the diffusion of light rays travelling onto the micro structure 111 will be further increased. The light rays entering the main body 10 are emitted from the light emitting surface 12 after being reflected by an inner structure of the main body 10.

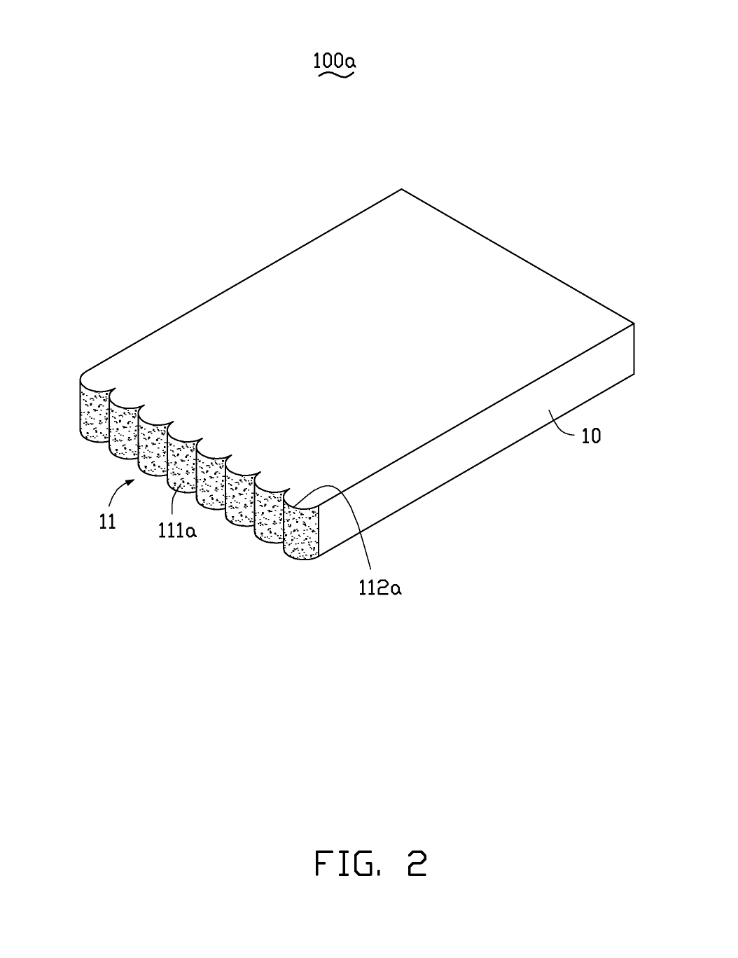

FIG. 2 shows a light guide plate 100a, according to a second exemplary embodiment. The difference between the light guide plate 100a of the second exemplary embodiment and the light guide plate 100 of the first exemplary embodiment is that the light guide plate 100a defines a micro structure 111a on the light incident surface 11. The micro structure 111a includes a number of protrusions 112a protruding from the light incident surface 11. A size of each transparent particle 20 is far less than a size of the protrusion 112a.

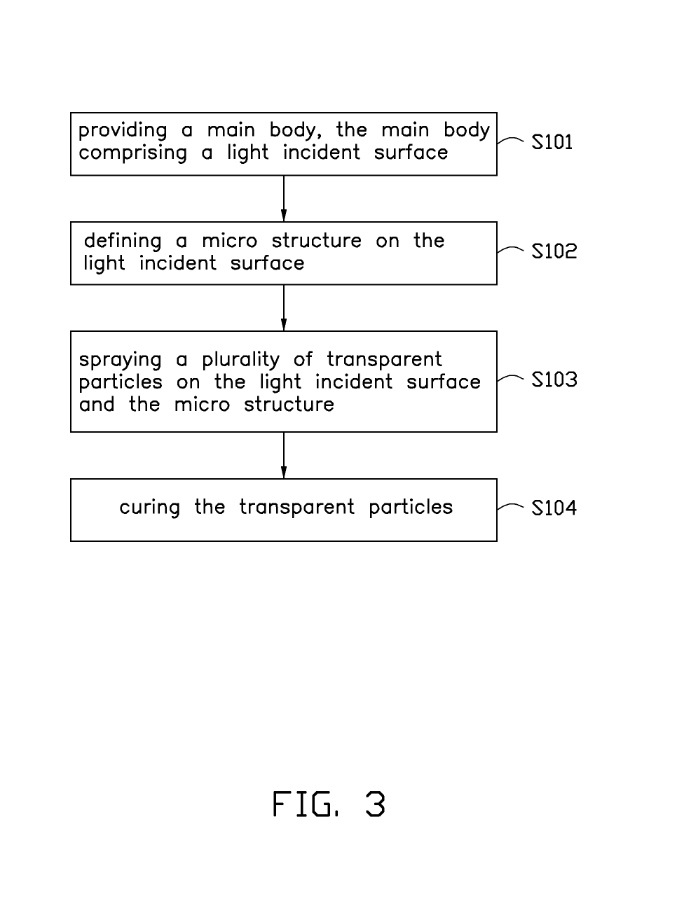

FIG. 3 shows a method of manufacturing either the light guide plate 100 or the light guide plate 100a, according to an exemplary embodiment. The method includes steps S101-S104.

S101: a main body 10 is provided, and the main body 10 includes a light incident surface 11.

S102: the main body 10 defines a micro structure 111 or 111a in the light incident surface 11. The micro structure 111 or 111a can be recesses 112 defined in the light incident surface 11 or can be protrusions 112a protruding from the light incident surface 11.

S103: a number of transparent particles 20 are sprayed to the light incident surface 11 and the micro structure 111, 111a. A refraction index n2 of the plastic material making of the transparent particles 20 is greater than a refraction index n1 of the plastic material making of the main body 10. A shape of each transparent particle 20 is irregular. A size of each transparent particle 20 is far less than a size of the recess 112 or a size of the protrusion 112a.

S104: the transparent particles 20 are cured on the light incident surface 11 and the micro structure 111, 111a via a baking process.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A light guide plate, comprising:
a main body comprising a light incident surface, and defining a micro structure in the light incident surface; and
a plurality of transparent particles attached on the light incident surface and the micro structure.

2. The light guide plate of claim 1, wherein a refraction index of the transparent particles being greater than a refraction index of the main body.

3. The light guide plate of claim 1, wherein the micro structure comprises a plurality of recesses defined on the light incident surface, a size of each transparent particle is far less than a size of the recesses.

4. The light guide plate of claim 1, wherein the micro structure comprises a plurality of protrusions protruded from the light incident surface, a size of each transparent particle is greatly far than a size of the protrusions.

5. The light guide plate of claim 1, wherein a shape of each transparent particle is irregular.

6. A method of manufacturing a light guide plate, comprising:
providing a main body, the main body comprising a light incident surface;
defining a micro structure in the light incident surface;
spraying a plurality of transparent particles on the light incident surface and the micro structure;
curing the transparent particles.

7. The method of claim 6, wherein a refraction index of the transparent particles being greater than a refraction index of the main body.

8. The method of claim 6, wherein the micro structure comprises a plurality of recesses defined in the light incident surface, a size of each transparent particle is far less than a size of the recesses.

9. The method of claim 6, wherein the micro structure comprises a plurality of protrusions protruded from the light incident surface, a size of each transparent particle is far less than a size of the protrusions.

10. The method of claim 6, wherein a shape of each transparent particle is irregular.
